(19) United States
(12) Patent Application Publication
(10) Pub. No.: US 2013/0200081 A1
(43) Pub. Date: Aug. 8, 2013

(54) BAKING PAN

(71) Applicant: Ian Wilkinson, Hong Kong (CN)

(72) Inventor: Ian Wilkinson, Hong Kong (CN)

(73) Assignee: WILKINSON CHINA LIMITED, Hong Kong (CN)

(21) Appl. No.: 13/879,070

(22) PCT Filed: Aug. 31, 2011
(86) PCT No.: PCT/GB2011/051635

§ 371 Date: Apr. 12, 2013

(30) Foreign Application Priority Data
Oct. 14, 2010 (GB) 1017347.4
Nov. 9, 2010 (GB) 1018915.7
Feb. 5, 2011 (GB) 1101798.5

(51) Int. Cl. A47J 37/01

(52) U.S. Cl. CPC A47J 37/01
USPC 220/573.1

(57) ABSTRACT

A baking pan including a body and a detachable base, wherein the body includes at least one wall and the base includes a rigid portion and a flexible seal, the seal being located between the rigid portion and the body. In a further embodiment, the body includes at least one wall and a flexible seal, the seal being located between the base and the body.

### FIELD OF THE INVENTION

The present invention relates to a baking pan having a detachable part, and in particular, although not exclusively, to a baking pan having a detachable part such as a base or lid and a detachable part, such as a base or lid, for use in a baking pan body.

### BACKGROUND TO THE INVENTION

A large variety of baking pans are used for domestic and commercial baking. They are used for baking food such as cakes, bread and the like. Known pans have a number of disadvantages.

Firstly, known pans often have the problem that cooked food sticks within the pan, making it difficult to extract the cooked food in one piece. One traditional solution is to make such baking pans with a loose base that allows upward pressure to the underside of the base to push out the cooked food from the pan. Owing to the base being a loose fit in the pan, the hot contents of the baking pan can seep or drain from where the loose base abuts the body of the baking pan.

Another traditional solution is to make baking pans with a detachable base that is clamped or locked into place by means of a spring clip or latch that is attached to the body of the pan. The clip, or latch, acts as a lever to lock the body of the pan onto the base of the pan for the duration of the baking process and then expand or open the body of the pan after baking is completed to release the cooked food on the base of the pan from the body of the pan. This style of baking pan is commonly called a springform baking pan.

Some styles of springform pans have more complex bases that incorporate a channel around the outer edge of the base, located in such a way as to catch and collect any leakage occurring between the base and the body during the baking or cooking process.

Another solution is to make a one piece baking pan, cut a hole in the base and then place an additional base into the pan covering the hole made in the base. To release the additional base and the cooked food from the pan, the additional base is pushed upwardly through the hole in the base.

However, all baking pans that have a loose or detachable base have the tendency to leak some of the contents of the pan during the cooking or baking process and/or to allow an ingress of water when the pan is immersed in a water bath (as for example when cooking a cheesecake in a Bain Marie).

It is therefore common practice to line baking pans having either a loose or detachable base with a lining material such as greaseproof paper, baking parchment or the like. The lining material covers the joints in the pan to render the interior of the baking pan virtually leak proof. However, it can be a time consuming and fiddly process cutting out the lining material and fitting it to the bottom of the baking pan. Indeed, fitting lining paper is not practical where the shape of the base of the baking pan is more complicated than, for example, a simple circle, square or rectangle.

A further problem with known pans exists because many people like to store cooked food in the original pan. Consequently most manufacturers make some baking pans with lids that are fastened over the top of the baking pan after cooking. However, existing lids trap a lot of air within the pan which aids deterioration of the food. An air gap will occur if the contents of the pan do not completely fill the body of the pan and/or the lid is raised above the body of the pan. Furthermore, existing pans are not effectively sealed to stop the flow of air between the inside and outside of the pan with the lid in place.

FIGS. 1 and 2 show a prior art baking pan 10. FIG. 1 shows baking pan 10 when used for cooking and FIG. 2 shows the baking pan 10 when used for storage. The baking pan 10 has a base 12 and a lid 14. Clips 16 hold the lid 14 in place on the base 12. The baking pan 10 is illustrated with food 18 contained therein. As the food 18 does not completely fill the base 12, a space A is present above the food 18 and within the body of the baking pan 10. A further space B is present within the lid 14. The combined space created by the spaces A and B results in a relatively large quantity of air being enclosed with the food 18.

An object of the present invention is therefore to provide an improved baking pan with a detachable part. When the detachable part is a base, a further aim is to provide a detachable base that minimises the egress of food during the cooking or baking process. When the detachable part is a lid, a further aim is to provide a lid and an improved baking pan with a lid that minimises the quantity of air trapped above the food and/or prevents air flow between the inside and outside of the baking pan, as and when the baking pan is used to store the cooked food.

Accordingly it is an aim of the present invention is to address at least one disadvantage associated with the prior art whether described herein or elsewhere.

### SUMMARY OF THE INVENTION

According to the present invention there is provided a baking pan and a baking pan base as set forth in the appended claims. Other features of the invention will be apparent from the dependent claims, and the description which follows.

According to the exemplary embodiments there is provided a baking pan having a body and a detachable part. The detachable part may be a lid or a base or any other detachable part. The body defines an opening between a side wall and, in use, the detachable part is able to be arranged to close the opening. A seal is provided between the detachable part and body to seal the opening when the detachable part is arranged to close the opening. The sealing of the baking pan is improved because the seal is arranged between the sidewall of the body and the detachable part. The sealing is improved because the seal is compressed between the detachable part and side wall which generates a push fit seal. Also, compression of the seal generates a force resisting movement of the detachable part relative to the base. Consequently, the sealing of the detachable part and base is not reliant on the weight of any ingredients or of the detachable part itself, bearing downwards on the seal. Consequently an improved seal is provided. Where the detachable part is a base and is inserted from the top to the bottom, the improved seal arrangement acts as a wiper as it moves downwards, wiping excess grease from the pan. It will be appreciated therefore that the side wall includes at least a portion having constant cross-section so that the seal may be compressed between the sidewall and detachable part at a number of locations. This is also applicable when the detachable part is a lid as it allows the lid to be moved up and down to accommodate different volumes of ingredients whilst maintaining the amount of air between the ingredients and lid.

There is therefore also provided a method of closing an opening in a body of a baking pan using a detachable part having a seal arranged on an edge thereof. Here, the method comprises moving the detachable part from a detached position to a first attached position wherein the seal is compressed between the sidewall of the body and the detachable part. The method may further comprise moving the detachable part from the first attached position to a second attached position wherein the second attached position is spaced from the first position in the direction of the opening.

The present invention includes any combination of the herein referred to features or limitations.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIGS. 1 and 2 show a cross sectional view of a prior art baking pan without and with the lid respectively;

FIG. 3 shows a partial cut-away perspective view of a baking pan according to an exemplary embodiment;

FIG. 4 shows a cross sectional view of a baking pan according to a first embodiment of the invention when not fully assembled;

FIG. 5 shows a cross sectional view of a baking pan of FIG. 4 when fully assembled;

FIG. 6 shows a cross sectional view of a baking pan according to a second embodiment.

FIG. 7 shows a cross sectional view of a baking pan according to a third embodiment.

FIG. 8 shows a cross sectional view through a base suitable for use in any of the baking pans of FIGS. 4 to 7;

FIG. 9 shows a cross sectional view through a further base suitable for use in any of the baking pans of FIGS. 4 to 7;

FIG. 10 shows a rigid portion of a further base suitable for use with a seal that completely covers the topside of the base such as in FIG. 9;

FIG. 11a shows a perspective exploded view of a further base suitable for use in any of the baking pans of FIGS. 4 to 7 and FIG. 11b shows an exploded cross sectional view of the base of FIG. 11a;

FIG. 12 shows a partial cross sectional view through a baking pan showing how a seal is compressed between a body and a rigid portion of the base of a baking pan;

FIG. 13 shows a further base suitable for use in any of the baking pans of FIGS. 4 to 7;

FIG. 14 shows a cross sectional view of a baking pan according to a fifth embodiment;

FIG. 15 is a schematic side view of an exemplary embodiment;

FIG. 16 shows a cross sectional view of a baking pan according to a further embodiment;

FIG. 17 shows a cross sectional view of a baking pan according to a sixth embodiment.

FIG. 18 shows an exemplary embodiment of a baking pan.

FIG. 19 shows a cross section through FIG. 18.

FIG. 20 shows a cross sectional view of a baking pan according to a further embodiment;

FIG. 21 shows a partial cross sectional view of a baking pan according to a further embodiment;

FIG. 22 shows a partial cross sectional view of a baking pan according to a further embodiment;

FIG. 23 shows a partial cross sectional view of a baking pan according to a further embodiment;

FIG. 24 shows a cross sectional view of a baking pan according to a further embodiment;

FIG. 25 shows a cross sectional view of a baking pan with the lid detached according to a further embodiment;

FIG. 26 shows a cross sectional view of the baking pan of FIG. 25 when fully assembled;

FIGS. 27 and 28 show alternative exemplary baking pans; and

FIGS. 29 and 30 show further alternative exemplary bases.

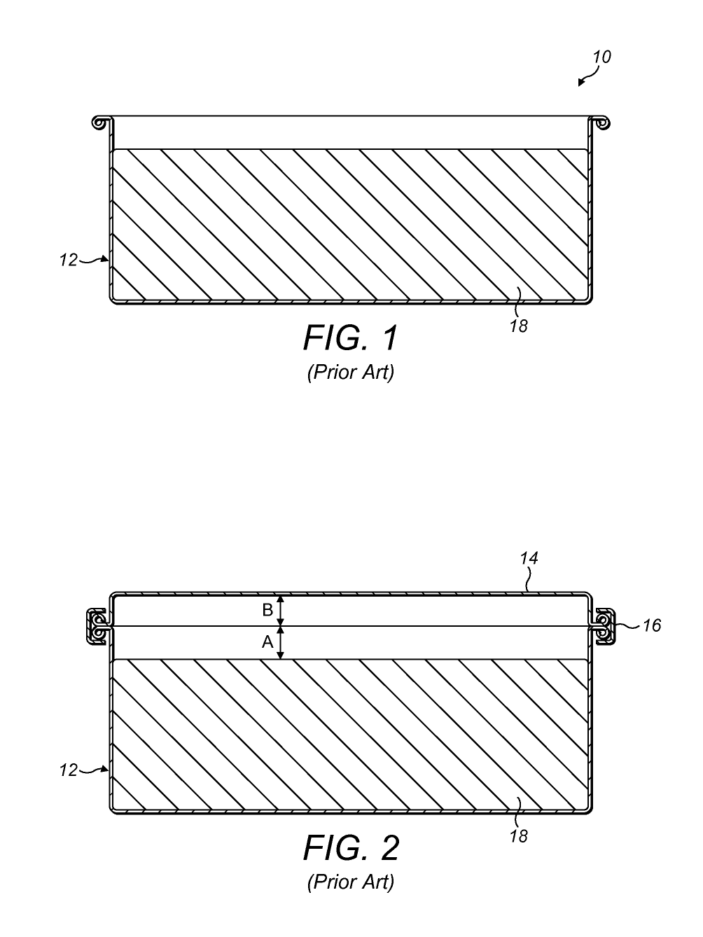

### DESCRIPTION OF THE PREFERRED EMBODIMENTS

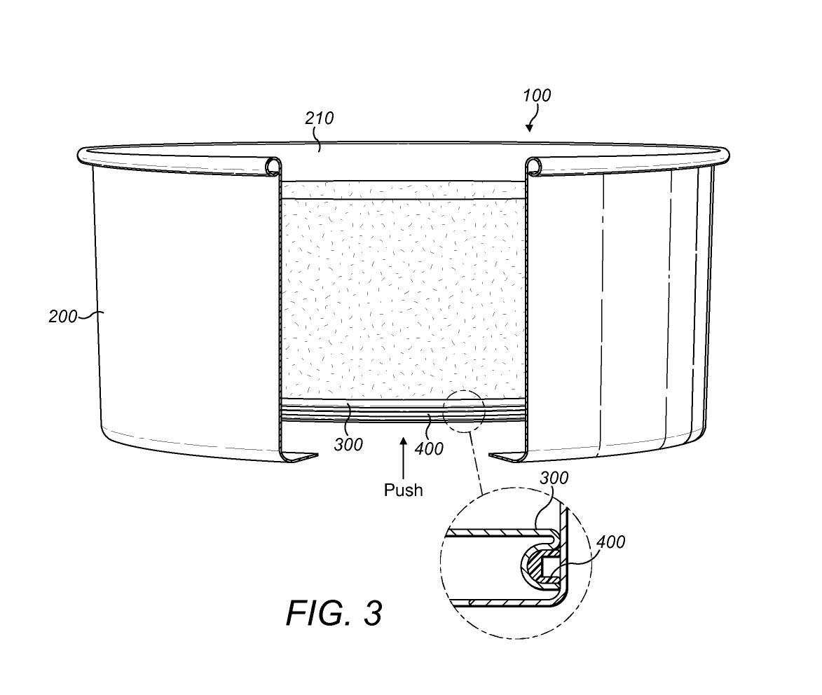

Referring to FIG. 3, a baking pan 100 is shown. The baking pan 100 comprises a body 200 and a detachable part 300. The body 200 forms a continuous side wall 210. The detachable part 300 has a rigid portion 310 for closing the continuous wall 210 of the body 200. A seal 400 is arranged between the rigid portion 310 and continuous wall 210 of the body 200. The rigid portion 310 has a front face 312 and a continuous side wall 314. The seal 400 is arranged between the continuous side wall 314 of the rigid portion 310 and the continuous side wall 210 of the body 200. The seal 400 is resilient and sized so as to extend, when uncompressed outside the periphery of the bodies continuous side wall 210. Consequently, when the detachable part 300 is pushed into the body 200, the seal 400 is compressed between the continuous side wall 210 of the body 200 and the continuous side wall 314 of the rigid part 310. Consequently, a push fit is formed. As will be herein described, the detachable part 300 may be a base, lid or other part of the baking pan.

Advantageously, when the detachable part 300 is a base, the seal 300 wipes the sides of the body 200 when inserted and removed. Consequently, the seal 400 acts as a wiper blade to remove excess cooking oil or grease that may have applied to the pan which results in healthier baking. Moreover, the seal provided between the continuous sides of the body and rigid part provides an improved seal which reduces leakage. Also, the seal is not reliant on the weight of the ingredients placed in the pan. Furthermore, when the pan is immersed in water (as for example when cooking a cheesecake over a Bain Marie) the improved seal prevents water ingress.

Additionally or alternatively, when the detachable part is a lid, advantageously, because the seal is provided between the continuous sides of the body and rigid part, a dynamic seal is provided that enables the lid to be pushed downwards to reduce the air void between the ingredients and lid.

Various exemplary embodiments will now be described wherein like parts have been given the same references.

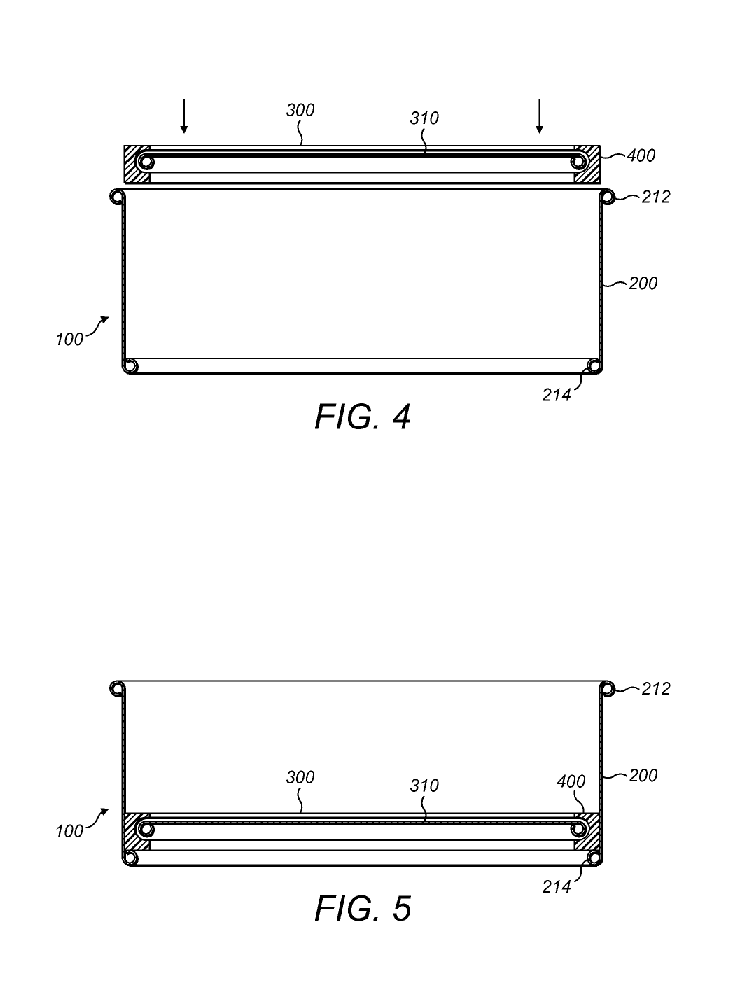

FIGS. 4 and 5 show a baking pan 100 according to a first exemplary embodiment of the invention. The baking pan comprises a body 200 and a removable part, shown in the exemplary embodiments of FIGS. 3 to 19 as a base 300. The base 300 is detachable from the body 200.

The body 200 is a single piece of metal formed into a continuous wall 210 in the shape of a circle by conventional means. The continuous wall 210 has an upper edge 212 and a lower edge 214. The upper edge 212 is rolled outwardly of the baking pan 200 and the lower edge 214 is rolled inwardly of the baking pan. The lower edge 214 forms a support for receiving the base 300.

The base 300 is circular in shape to fit in the body 200. The base 300 comprises a rigid portion 310 and a seal 400. The rigid portion 310 is a metal plate. The seal 400 is flexible and heat resistant and is located around the edge of the rigid portion 310.

The seal 400 is pre-moulded and stretched over the rigid portion 310. The seal 400 is preferably made of silicone rubber, but may be made of any material having suitable properties.

The seal 400 is such that the base 300 can pushed downwardly into the body 200 to rest on the support 214. The seal 400 also allows the base 300 to be removed from the body 200 by pushing the base 300 upwardly with respect to the body 200. The presence of the seal 400 makes the base 300 slightly larger in diameter than the internal diameter of the body 200. This allows a push fit of the base into the baking pan. When the base 300 is in situ on the support 214, the seal 400 is compressed sufficiently to prevent egress of food from the baking pan 100 during the normal baking or cooking process.

FIG. 4 shows how the base 300 is lined up with the body 200 before being pushed into the operation position as shown in FIG. 5.

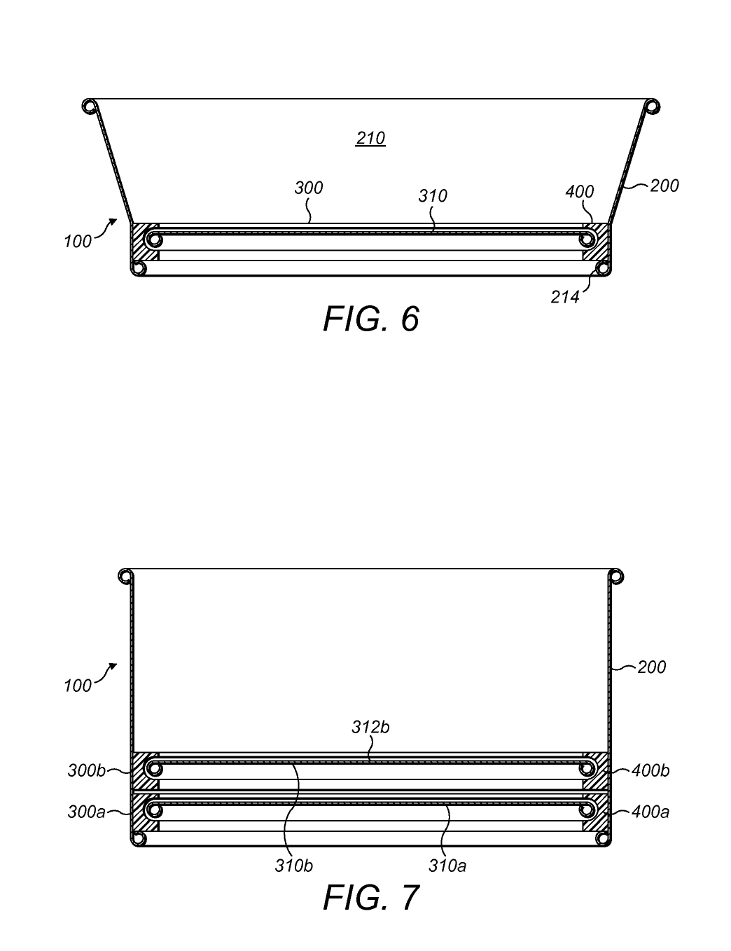

FIG. 6 shows a second exemplary embodiment of a baking pan 100. The baking pan 100 comprises a body 200 and a base 300. The base 300 comprises a rigid portion 310 and a seal 400. The baking pan 100 differs from that of FIGS. 4 and 5 in that the body 200 is not completely vertical. That is, a continuous side 210 of the base 200 does not have a constant diameter. Rather, the continuous side is tapered so as to get narrower towards the support 214. However, a vertical or near vertical section 212 (e.g. a section with constant cross-section) is incorporated in the body 200 to provide a good fit with seal 400.

FIG. 7 shows a third exemplary embodiment of a baking pan 100. The baking pan 100 comprises a body 200, and a base 300 comprising a first base 300a. The first base 300a comprises a rigid portion 310a and a seal 400a. Additionally, a second base 300b is provided. The second base 300b comprises a rigid portion 310b and a seal 400b. The second base 300b is the actual cooking surface of the base of the baking pan 210. That is, a front face 312b of the second base provides the surface for receiving cooking ingredients. An air gap between the first base 300a and the second base 300b is formed and acts to insulate the second base 300b and prevent burning of the mixture of ingredients in contact with the front face 312b during the baking or cooking process. Additionally, a layer or insulation material may be placed between the first base 300a and the second base 300b to give even better insulation properties to the whole structure of the base 300. The first base 300a and the second base 300b may be separate items as shown in FIG. 7 or formed integrally, with or without insulation in the air gap.

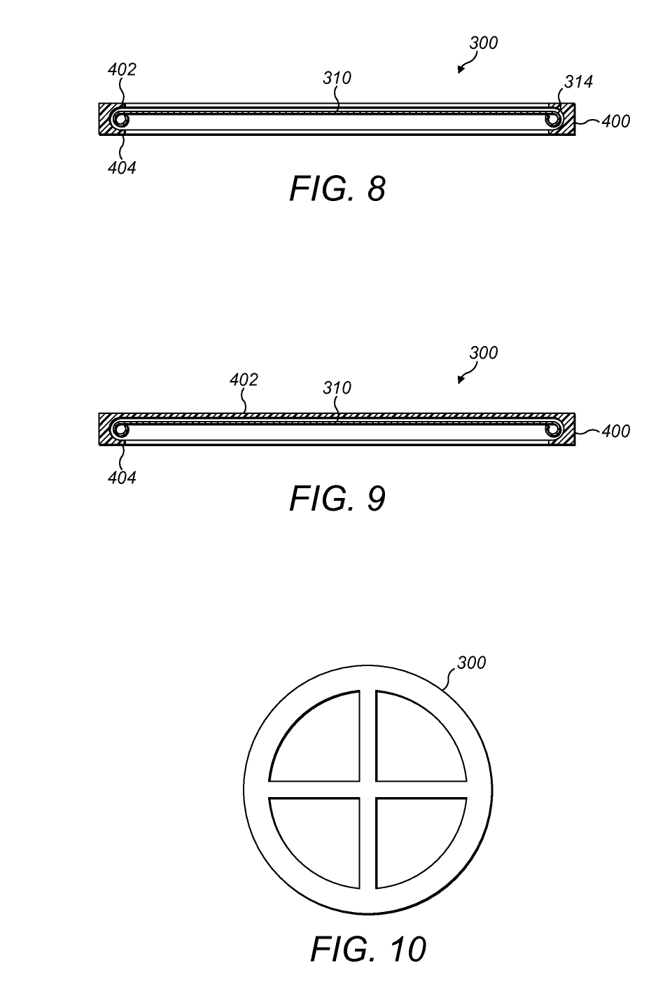

FIG. 8 shows a particularly suitable base 300 for use in any of the baking pans of FIGS. 3 to 7. The base 300 comprises a rigid portion 310 and a seal 400. The rigid portion 310 is a metal plate. The seal 400 is flexible and is located around the continuous edge 314 of the rigid portion 310. The seal 400 may be pre-moulded and stretched over the rigid portion 400. Various arrangements of seal 400 are suitable. For instance, in FIG. 8, the seal 400 includes top and bottom rims 402, 404 that have a reduced diameter to a seat 406 for receiving the continuous side 312. The top and bottom rims maintain the seal in position when it slides against the base 200. In

FIG. 9 the top rim is a continuous surface that covers across the top of the base 300. Alternatively the seal 400 could extend over part of the top of the base 300. Alternatively, or additionally the seal 400 could extend under part or all of the bottom of the base 300. The seal 400 may be pre-moulded and stretched over the rigid portion 310.

FIG. 10 shows a rigid portion 300 of a further base in the form of a frame. The frame is a stamped frame. However, such frames could also be made by fabrication, for example from wire.

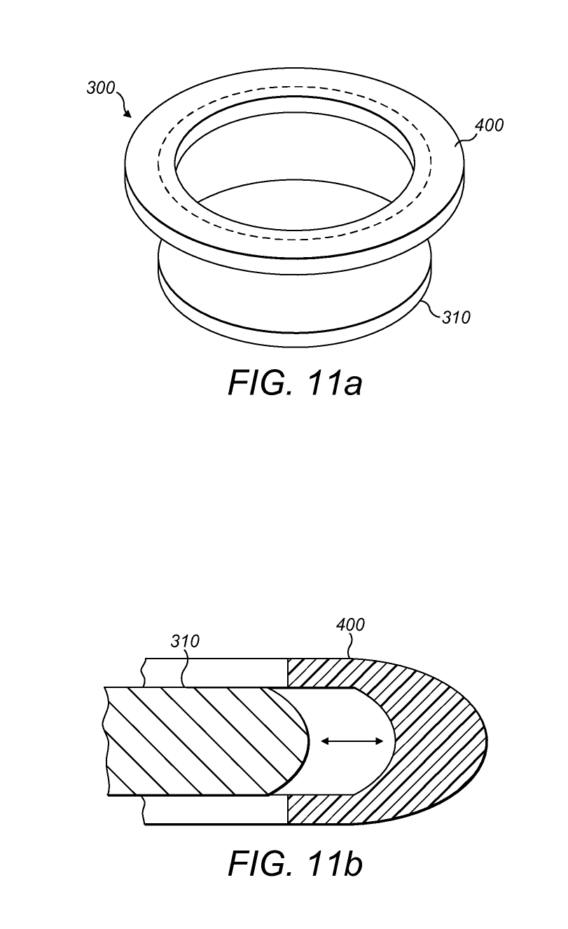

FIGS. 11a and 11b show exploded views of a further exemplary base 300. The base 300 comprises a rigid portion 300 and a seal 400. The seal 400 is shaped to capture the rigid portion 300 when it is stretched over or formed around the rigid portion 300.

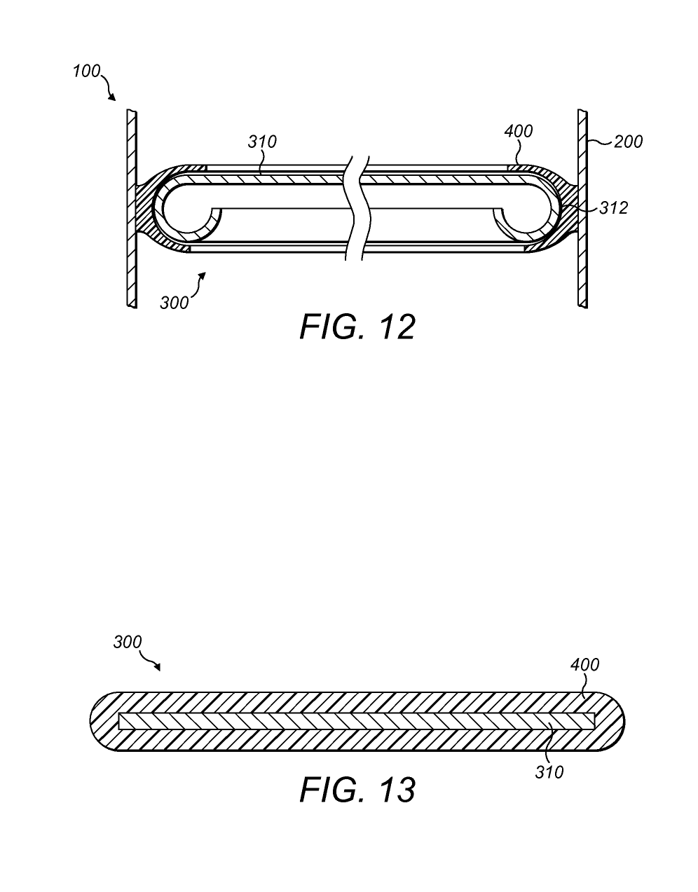

FIG. 12 shows a seal 400 compressed between a body 200 of a baking pan 100 and the outer edges of the rigid portion 312 of the base 300 to make a seal.

FIG. 13 shows a further exemplary base 300 having a rigid portion 310 in the form of a wire frame. A seal 400 covers the outer edge of the rigid portion 310 and extends across all of the top and bottom of the wire frame to ensure a continuous base through which no cooking material can leak. Alternatively the seal 400 could extend across just the top or the bottom of the frame.

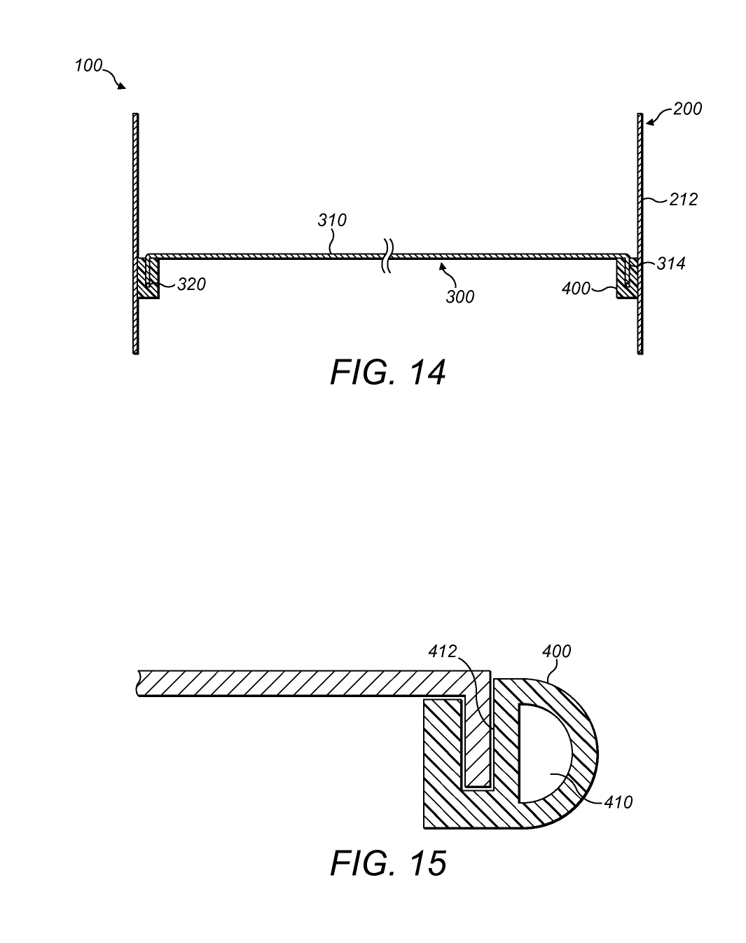

FIG. 14 shows a further exemplary embodiment of a baking pan 100 according to the present invention. The baking pan 100 comprises a body 200 and a base 300. The base 300 comprises a rigid portion 310 and a seal 400. The rigid portion 310 has an outer edge portion 314 formed substantially at right angles to the main rigid portion 310 and extending downwardly in use. The seal 400 is located on the outer edge portion 314. The outer edge portion 314 may be provided with a plurality of holes 320 that allow the seal 400 to be attached or moulded through the base 300. The seal 400 is such that, in use, it extends level with, or below, the front face 312 that comes into contact with the food. Because the seal does not extend above the front face 312 this enables the cooked food to be cut into portions after removal from the base 200, but whilst still standing on the base 300, without the knife or other cutting implement making any significant damage to the seal 400.

FIG. 15 shows a further exemplary seal arrangement. Here the seal 400 includes a hollow section 410 that improves the compressibility of the seal. The seal may be attached to the base in a similar manner to any of the previous exemplary embodiments. However, in FIG. 15, the seal is shown as including a channel 412 for receiving a downwardly bent outer profile 314 of the rigid portion. To promote good adhesion between the seal and rigid portion and to prevent the seal from moving on the rigid portion, it may be glued or over moulded or otherwise attached.

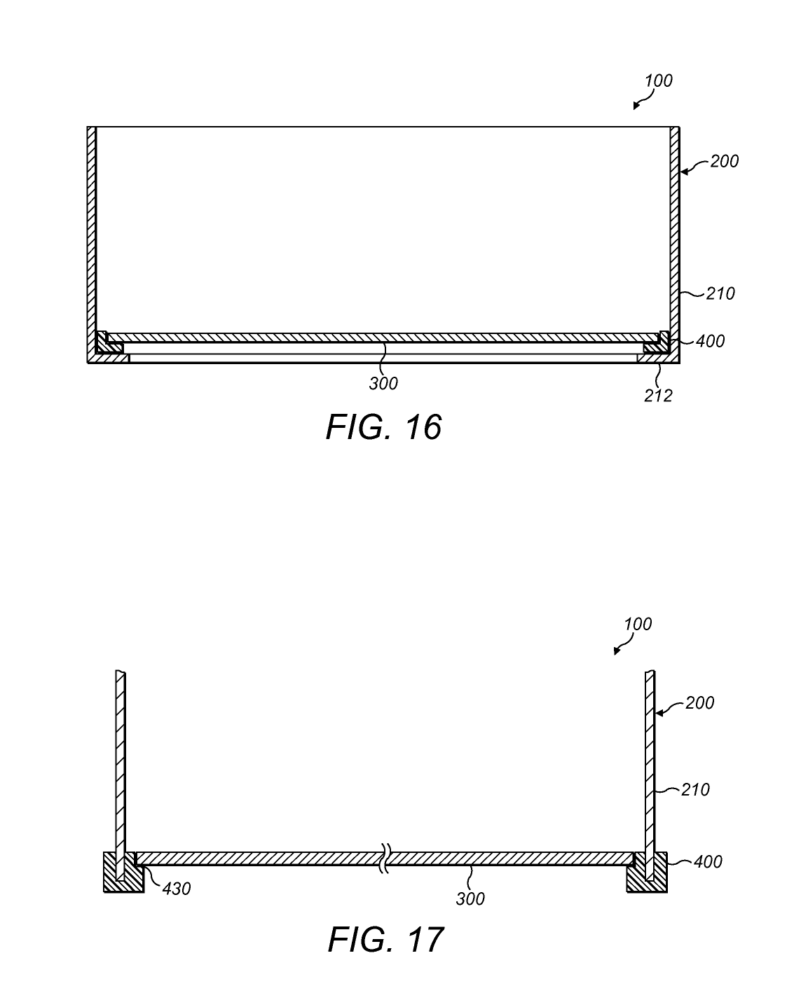

FIGS. 16 and 17 show a further exemplary embodiment of a baking pan 100 wherein the seal 400 is attached to the base rather than the detachable part. In FIG. 16, the baking pan 100 comprises a body 200 and a base 300. The body 200 comprises a side wall 210 and a seal 400. The wall 210 has a lower edge 212 formed inwardly of the baking pan 100 on which the seal 400 is located. The lower edge 212 forms a support for receiving the base 300. The base 300 is slightly larger in diameter than the internal diameter of the seal 400 of the body 200. This allows a push fit of the base 300 into the baking pan 100. When the base 300 is in situ on the support 212, the seal 400 is compressed sufficiently to prevent egress of food from the baking pan 100 during the normal baking or cooking process. Although the seal is “L” shaped, the important seal is formed between the edge of the rigid portion and side wall of the base, which generates the push fit and creates a force resisting movement of the seal.

FIG. 17 shows a further exemplary embodiment of a baking pan 100. The baking pan 100 comprises a body 200 and a base 300. The body 200 comprises a wall 310 and a seal 400. The seal 400 is attached to, or moulded onto, the bottom edge of the wall 210 and extending up a lower portion of the wall 210. The seal 400 has a recess 430 extending around the top inner circumference thereof for receiving the base 200.

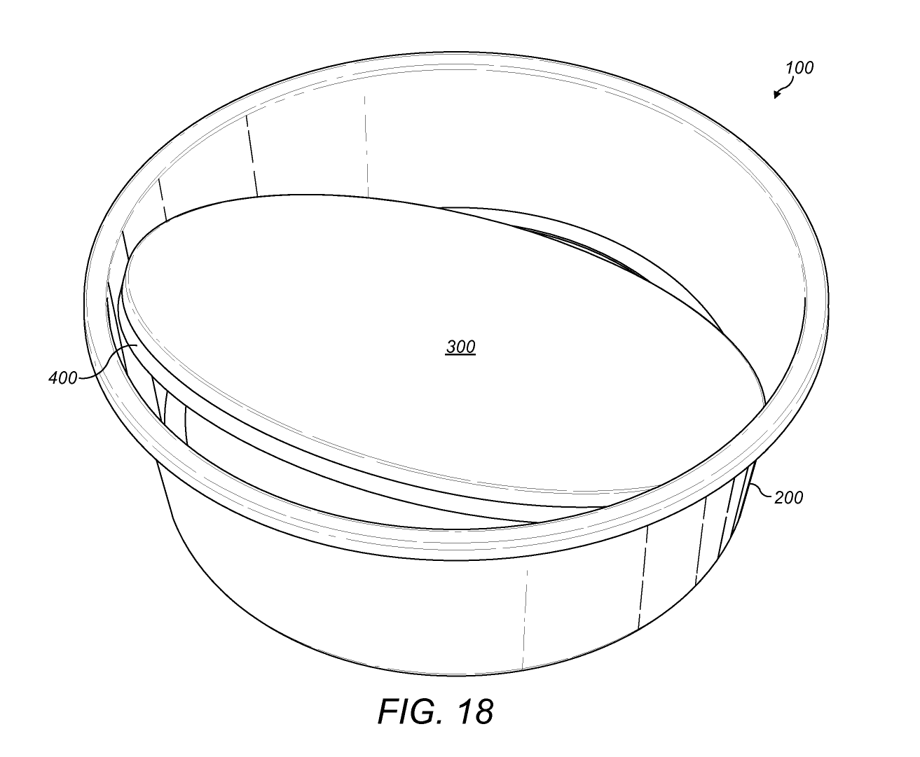

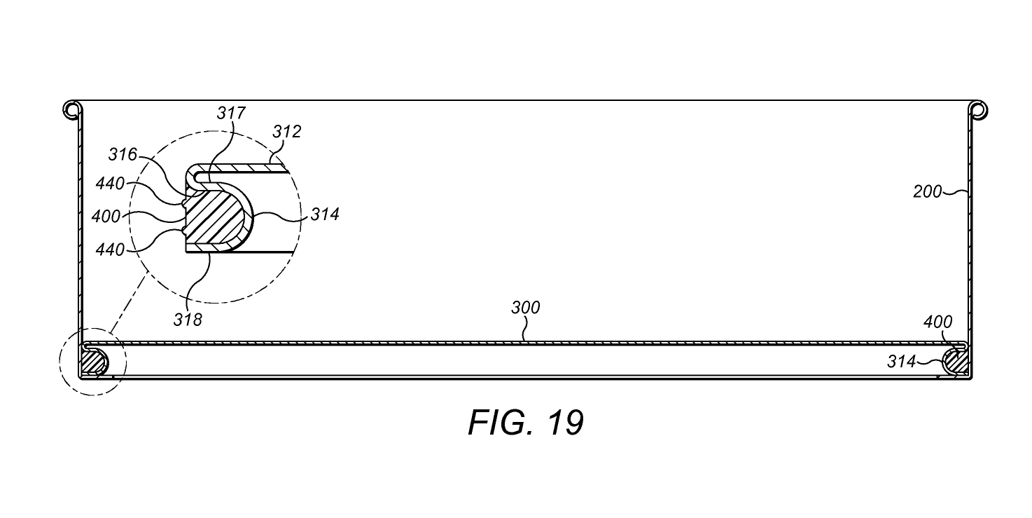

Referring to FIGS. 18 and 19 a particularly suitable exemplary embodiment is shown. Here the baking pan 100 comprises a body 200 and base 300. A seal 400 is arranged on a continuous side edge of the base 300. As shown in detail in FIG. 19, the base 300 includes a substantially flat top surface 312 for receiving cooking ingredients, though, for instance, it may be stamped, moulded or embossed with a decorative form. The continuous side 314 may be formed to include a seat 316 within which the seal 400 sits. The seat 316 is therefore defined by upper and lower portions 317, 318 and these may be formed by forming the rigid portion into a series of bends. The seal 400 is substantially continuous and can be stretched over one of the upper or lower portions 317, 318 so that the seal is replaceable and held tightly in position to prevent movement when sliding against the base. As will be appreciated, the seal 400 is a larger external size than the base 300. Annular rings or flaps 440 may be included to provide the increased size and to improve deformation of the seal.

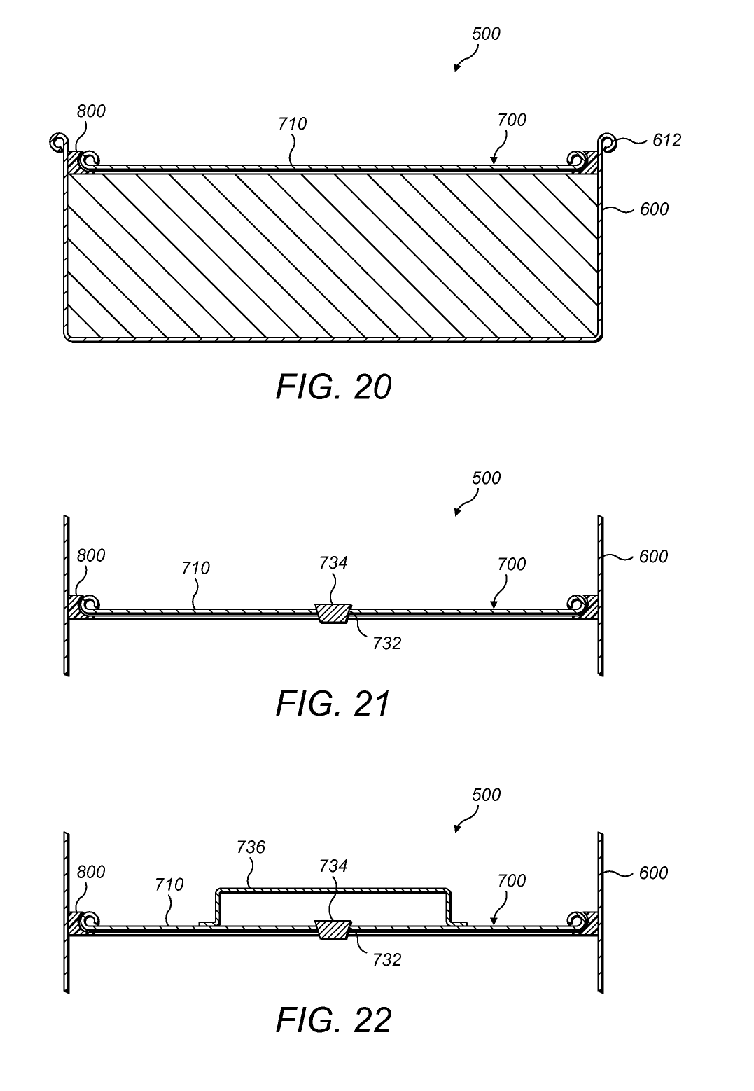

FIG. 20 shows a baking pan 500 according to an alternative exemplary embodiment wherein the detachable part comprises a lid. The baking pan 500 comprises a body 600 and the lid 700. The body 600 is circular in plan view and is constructed from a single piece of metal by conventional means. The body 600 has an upper edge 612 rolled outwardly of the baking pan 500.

The lid 700 is circular in shape to fit in the body 500. The lid 700 comprises a rigid portion 710 and a seal 800. The rigid portion 710 is a metal plate. The seal 800 is flexible and heat resistant and is located around the edge of the rigid portion 710. The seal 800 is pre-moulded and stretched over the rigid portion 710. The seal 800 is preferably made of silicone rubber, but may be made of any material having suitable properties.

The seal 800 is such that the lid 700 can be pushed downwardly into the body 600 to rest against food contained in the baking pan 500. This minimizes the amount of air contained within the body 600 and the lid 700. The presence of the seal 800 makes the lid 700 slightly larger in diameter than the internal diameter of the body 600. This allows a push fit of the lid 700 into the baking pan 500, such that the seal 800 is compressed sufficiently to prevent air entering or leaving the inside of the baking pan 500.

FIG. 21 shows a partial cross sectional view of a further exemplary baking pan 500. The baking pan 500 comprises a body 600 and a lid 700. The lid 700 comprises a rigid portion 710 and a seal 800. The rigid portion 710 of the lid 700 has an air hole 732 that allows air to flow out of, or into, the body 600 of the baking pan 500 as the lid 700 is pushed in or out of the baking pan 500. The air hole 732 is easily closed when the lid 700 is in place in the body 600 of the baking pan 500 by a bung 734 made from a suitable material, typically silicone rubber. Once the bung 734 is in place the whole structure of the baking pan 500, i.e. the body 600 and the lid 700, will effectively be a sealed unit. Alternatively, the air hole 732 may be closed by a stopper or other device made from a suitable material. More than one air hole 732 may be provided in the lid 700, each air hole 732 being adapted to be closed by a respective bung 734.

The air hole 732 allows the lid 700 to be easily pushed into position within the body 600 of the baking pan 500 with the air hole 732 open whilst the cooked food is still cooling and/or without compressing any air within the body 600 of the baking pan 500. The bung 734 may be fitted in the air hole 732 when the lid 700 is in position and the contents of the baking pan 500 are considered to be close enough to ambient room temperature. This would prevent a partial vacuum (vacuum effect) forming in the sealed baking pan 500, as happens when a warm, sealed unit is cooled to a temperature below that when the unit is sealed. The lid 700 could be pushed down onto the cooked food to minimize the amount of trapped air in contact with the food and thereby improve storage life.

Alternatively, the air hole 732 could be sealed with the bung 734 after the lid 700 has been pushed into position, but while the pan and cooked contents are still hot or warm after the cooking process. Consequently, as the cooked contents within the pan continue to cool down to ambient room temperature or any lower temperature as created by a domestic fridge or freezer, a vacuum effect will occur within the sealed unit. This vacuum effect will enhance the normal longevity and/or freshness and/or fitness for consumption of whatever cooked foods are in the pan.

FIG. 22 shows a partial cross sectional view of a baking pan 500 according to a further exemplary embodiment. The baking pan 500 comprises a body 600 and a lid 700. The lid 700 comprises a rigid portion 710 and a seal 800. The rigid portion 710 of the lid 700 has an air hole 732 for receiving a bung 734 and a handle 736 to enable easy insertion and removal of the lid 700 into and out of the baking pan 500. The bung 734 is removed from the air hole 732 before the lid 700 is inserted into or removed from the body 600 of the baking pan 500. The handle 736 enables easy removal of the lid 700 when the body 600, especially when the body 600 does not have a detachable base.

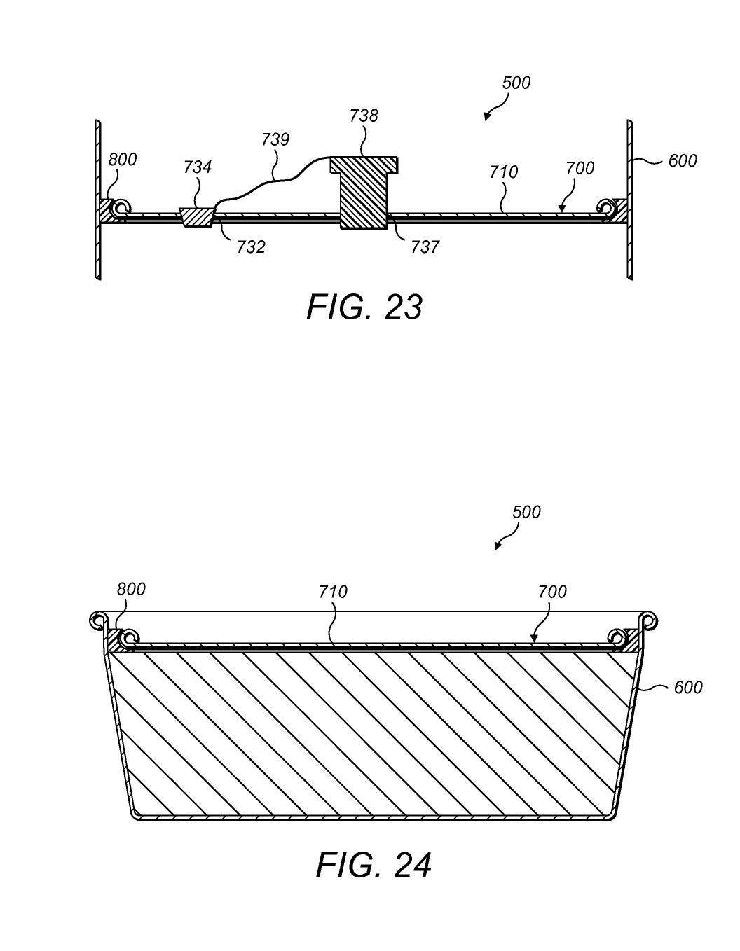

FIG. 23 shows a partial cross sectional view of a baking pan 500 according to a further exemplary embodiment. The baking pan 500 comprises a body 600 and a lid 700. The lid 700 comprises a rigid portion 710 and a seal 800. The rigid portion 710 of the lid 700 has an air hole 732 for receiving a bung 734 and a handle hole 737 in which a handle (knob) 738 is inserted. The knob 738 is connected to the bung 734 by connection means 739, so that the bung 734 attached to the lid 700 and cannot be lost. The bung 734, the knob 738 and the connection means 739 may be moulded in one piece from silicone rubber, whereby the connection means 739 is a simple band or strip of material. However, the bung 734, the knob 738 and the connection means 739 may be formed of other materials and may be independently formed and subsequently joined together. The knob 738 may be constructed to be pushed into place on the rigid portion 326.

FIG. 24 shows a cross sectional view of a baking pan 500 according to a further embodiment. The lid 700 is substantially as described with reference to FIG. 20. The baking pan comprises a body 600 and a lid 700. The lid 700 comprises a rigid portion 710 and a seal 800. The body 600 has tapered sides, and the lid 700 is of a size such that when pushed into the body 600, it stops within the upper portion of the pan at a pre-determined position.

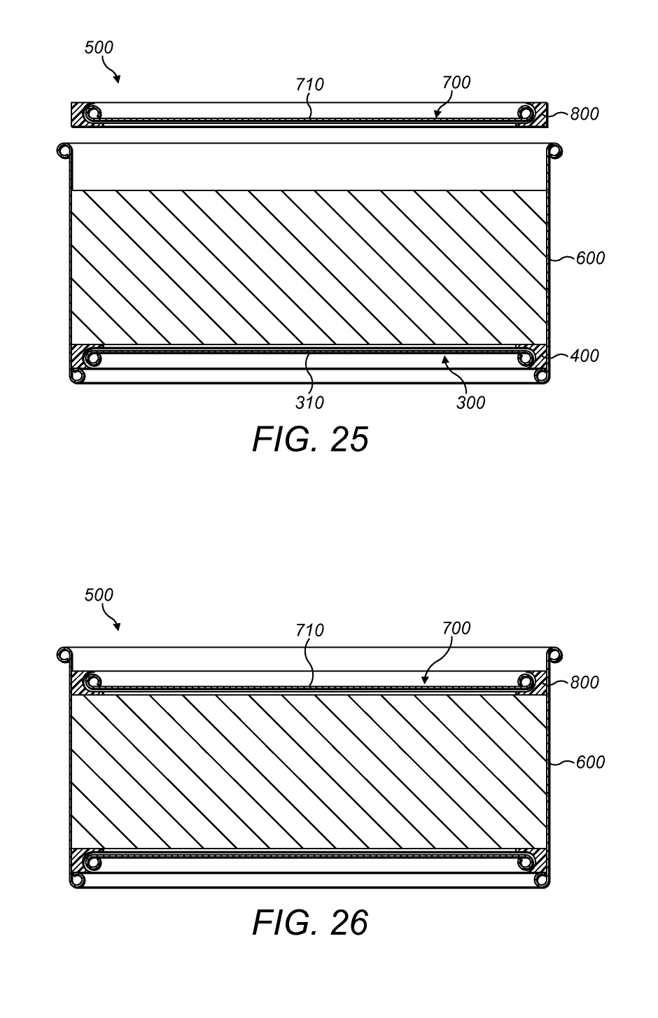

FIGS. 25 and 26 show cross sectional views of a baking pan 500 of a further exemplary embodiment. The baking pan 500 comprises a body 600, and a lid 700. The base 300 comprises a rigid portion 310 and a seal 400. The lid 700 comprises a rigid portion 710 and a seal 800. The lid 700 is identical to the base 300, although this is not essential. The lid 700 can be used as described with reference to FIG. 20 to cover and seal the cooked food 500. In the embodiment of FIGS. 25 and 26 the whole contents of the baking pan 500, namely the base 600, the cooked food and lid 700 can simply be removed from the baking pan as required by pushing the base 300 out of the baking pan 500. This does not require the removal of any bung(s) from any air hole(s) that may be incorporated in the construction of the lid 700.

The lid 700 according to the exemplary embodiments described herein may be used in conjunction with any conventional baking pan with a solid, detachable or loose base, including a springform baking pan. A springform baking pan has a detachable base that is clamped or locked into place by means of a spring clip or latch that is attached to the body of the pan. The clip, or latch, acts as a lever to lock the body of the pan onto the base of the pan for the duration of the baking process and then expand or open the body of the pan after baking is completed to release the cooked food on the base of the pan from the body of the pan.

Alternatively, the lid 700 can be used as a second base. The lid 700 when used as a second base is pushed right the way down into the body 600 to abut the first base 300 to form the actual cooking surface of the base of the baking pan. The air gap between the base 300 and the second base 700 acts to insulate the second base 700 and prevent burning of the base of food during the baking or cooking process.

The lid of the present invention could be used in conjunction with any baking pan, the body of which has an air-tight and/or sealed construction. The degree of air-tightness of the overall assembly needs only to be high enough to seal against airflow and, optionally, to provide a moderate and entirely safe vacuum effect to aid the preservation of cooked food within the typical, domestic environment.

It is foreseen that the baking pan of the present invention could incorporate a safety valve within the lid or the body of the baking pan. The valve is designed to increase the pressure of the partial vacuum by allowing ingress of air, should the pressure ever reach a predetermined lower limit that may be set from time to time by the manufacturer or any relevant safety authority. Such a safety valve would preferably be manufactured using silicone rubber or any other appropriate material or method. Furthermore, a vacuum pump could be attached to the valve to enable air to be withdrawn from within the sealed assembly, to further enhance (lower) the pressure of the partial vacuum if required.

In embodiments of the invention where a seal is attached to a body of a baking pan, the seal may be located on any suitable shelf formed by the body or may be attached to the body by means of rivets, welding or other suitable methods

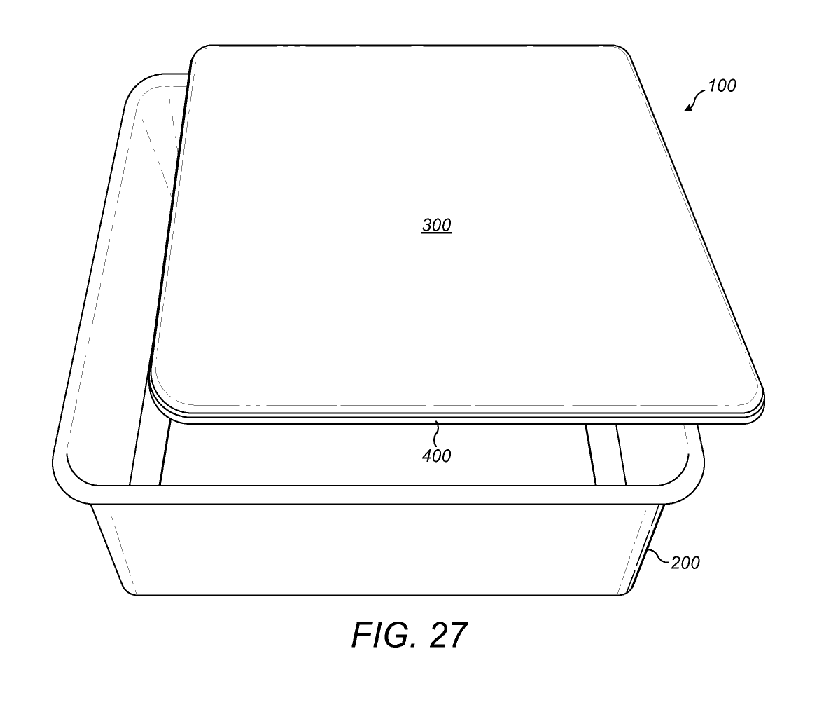

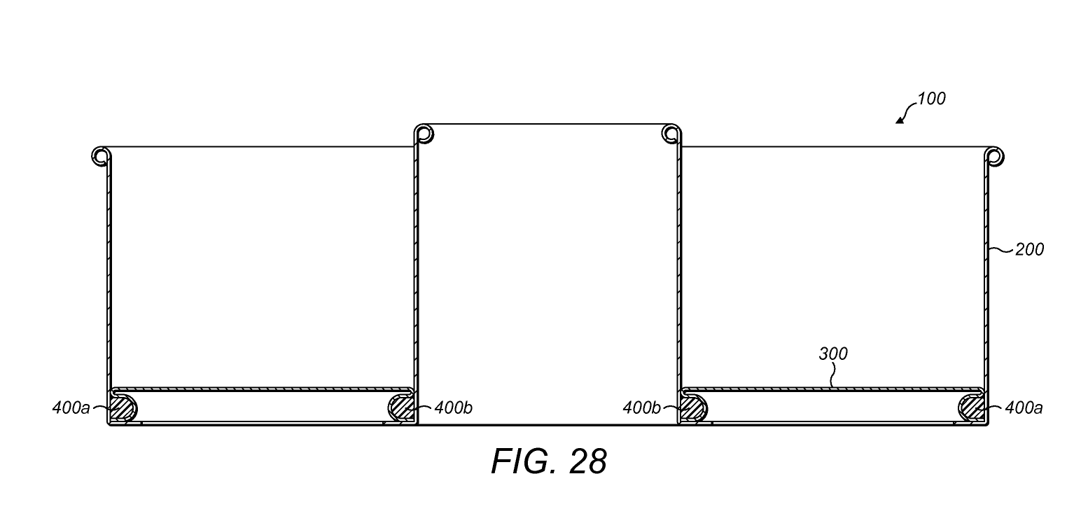

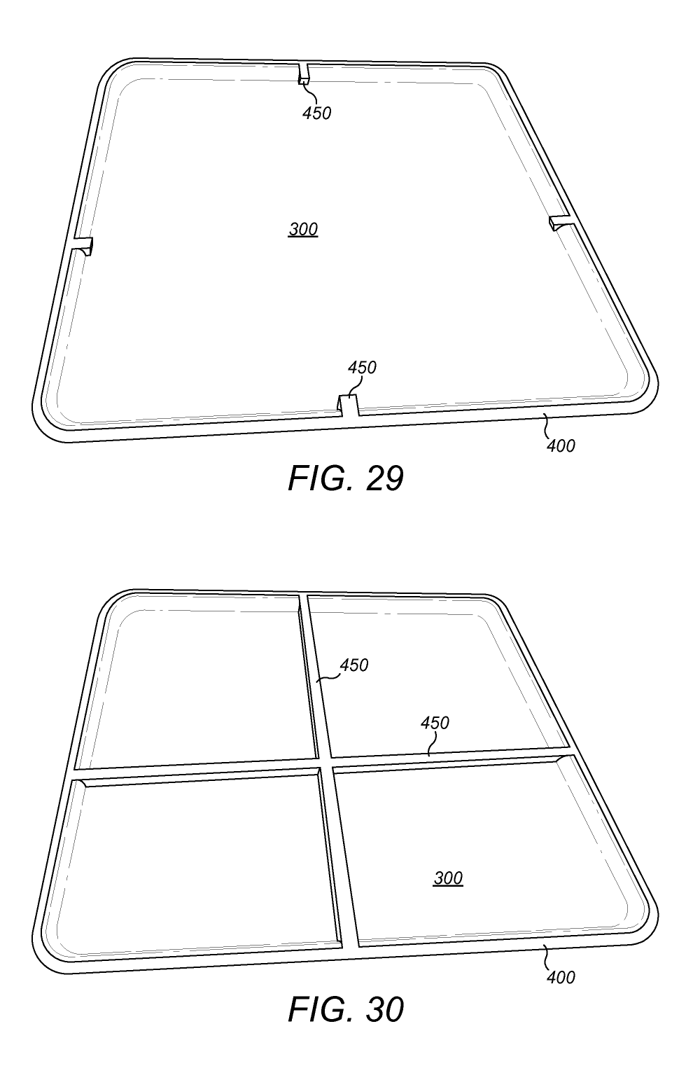

Although the baking pan has been described with reference to a circular baking pan, it may take any suitable shape, which may be a multiple-sided shape such as a square or a star. As an example, FIG. 27 shows a square form baking pan 100 having a body 200, base 300 and seal 400 that is arranged on a side of the base. The baking pan may also be a springform baking pan. As a further example, FIG. 28 shows a ring cake pan wherein the pan includes a central tube so that the ingredients form a ring. Here a first seal is formed on the outside of the base for sealing with the base as herein described. However, in addition, the base includes a hole for receiving the central tube and a second seal 400b is provided to seal against the tube. In the instances of complex shapes, extra securing means may be necessary to prevent the seal from moving relative to the base. The securing means may be adhesive or other means of affixing the seal to the base. However, lugs 450 may be used as shown in FIG. 29. The lugs 450 of the seal may co-operate with slots in the base. Additionally or alternatively, as shown in FIG. 30 the lugs 450 on opposed sides may be joined. By connecting the lugs 450, tension can be applied to the seal to prevent it from becoming floppy, particularly on long, straight sides.

Some baking pan bodies are formed by stamping and therefore the wall or walls of the body of the pan have no joint or joining. Other baking pan bodies are formed by fabrication where there will be a joint or joints in the vertical plane of the wall or walls of the pan. Where such joints are part of the structure of the baking pan body, they may result in a deformity such as a crack or bulge in the wall or walls. However, with the sealing arrangement of the present invention, the compression ability and/or shaping of the seal provides an effective seal around any such deformity.

The seal is preferably made from silicone rubber, which is very easy to shape or fabricate, but any other suitable material may be used. Silicone rubber can be extruded, injection moulded, compression moulded, liquid injection moulded or calendered. The relative ease with which silicone rubber is moulded and/or formed in the production process allow complex designs such as numbers, letters and various styles of baking pan to be made with detachable bases.

Although the invention has been described with reference pre-moulded seals, the seals may be applied to the rigid portions by other means such as over moulding or injection moulding. Furthermore the pre-moulded seal is not limited to being stretched over the rigid portion. For example, the seal may comprise one or more sections that are clipped or snapped into locators on the rigid portion.

Providing a baking pan of the type having detachable base, in which the base or the body has an integral seal, means that the user of the baking pan does not need to cut out and line the base with greaseproof paper, baking parchment or the like. This saves the user much time and effort. Furthermore, as the seal is incorporated into either the base or the body of the baking pan, the baking pan is still a two-part baking pan as far as the user is concerned. The pan is therefore easy to assemble and clean. The push fit of the base into the body of the baking pan compresses the seal to ensure that no leakage of food occurs during the cooking or baking process.

The seal must be capable of preventing the egress of the food in a baking pan between the base and the body. A baking pan usually holds food in the form of mixtures of baking materials as commonly used in the baking of cakes and confectionery. The seal does not necessarily have to prevent the egress of other materials.

In the embodiments described above, whether the base comprises the seal or the body comprises the seal, the construction is always such that a push fit of the base into the baking pan is made and the seal is compressed between the body and the base of the baking pan.

The support for the detachable base of the baking pan may be formed in any suitable way, either from the body of the baking pan itself or some other device or devices attached to the body of the baking pan.

Although the invention has been described with reference to a rigid portion being in the form of a metal plate, it may also take any other suitable form such as a frame.

The frame may be stamped frame or may be made by fabrication, for example from wire. Likewise, the rigid portion could be made from glass or cast metal or any suitable material.

The present invention thus provides a lid which enables air trapped above cooked food to be minimised and seals the contents of the baking pan against airflow. Optionally, the lid may be used to create a vacuum effect in the trapped air.

Although preferred embodiment(s) of the present invention have been shown and described, it will be appreciated by those skilled in the art that changes may be made without departing from the scope of the invention as defined in the claims and that all of the features disclosed may be combined in any combination, except combinations where at least some of such features and/or steps are mutually exclusive.

1. A baking pan comprising a body and a detachable part, wherein the body comprises at least one side wall defining a first opening and the detachable part comprises a rigid portion that is able to be arranged to close the first opening;
the baking pan further comprising a flexible seal, the seal being located between the rigid portion and the side wall of the base when the detachable part closes the first opening.

2. The baking pan according to claim 1, wherein the detachable part is a push fit in the body.

3. The baking pan according to claim 1, wherein the body is a springform body.

4. The baking pan according to claim 1, wherein the rigid portion comprises a plate and the seal is located around the edge of the plate.

5. The baking pan according to claim 1, wherein the rigid portion comprises a framework and the seal covers an upper surface and the edge of the framework.

6. The baking pan according to claim 1, wherein the seal is pre-molded and subsequently stretched over the rigid portion.

7. The baking pan according to claim 1, wherein the seal is overmolded on the rigid portion.

8. The baking pan according to claim 1, wherein the seal is injection molded on the rigid portion.

9. The baking pan according to claim 1, wherein the at least one side wall has a portion of constant cross-section for receiving the detachable part.

10. The baking pan according to claim 1, wherein the at least one side wall has a portion of tapered cross-section for receiving the detachable part.

11. The baking pan of claim 1, wherein the seal is attached to the detachable part.

12. The baking pan of claim 1, wherein the seal is attached to the body.

13. The baking pan according to claim 12, wherein the seal is molded or attached over a bottom edge of the wall.

14. The baking pan according to claim 12, wherein the seal provides a ledge for receiving the detachable part.

15. A detachable part base for use in a baking pan comprising a rigid portion and a flexible seal, the seal being arranged on a side of the detachable part and adapted to provide a seal between at least one side wall of the baking pan body and the rigid portion of the detachable part, when the detachable part closes the opening of the baking pan.

16. The baking pan according to claim 1, wherein the detachable part is a base.

17. The baking pan according to claim 1, wherein the detachable part is a lid.

18. The baking pan or detachable part according to claim 17, wherein the lid has at least one air hole, and a detachable stopper is located in each said air hole.

19. The baking pan according to claim 17, wherein the lid includes a handle.

20. The baking pan according to claim 17, wherein the lid or the body includes a valve.
